(19) United States
(12) Patent Application Publication
(10) Pub. No.: US 2020/0193107 A1
(43) Pub. Date: Jun. 18, 2020

(54) BAR-CODE READER WITH SPECULAR REFLECTION IMMUNITY

(71) Applicant: Zebra Technologies Corporation, Lincolnshire, IL (US)

(72) Inventors: Vladimir Gurevich, Great Neck, NY (US); Matthew D. Blasczak, Shirley, NY (US); Michelle X. Wang, Mount Sinai, NY (US); David P. Goren, Smithtown, NY (US)

(21) Appl. No.: 16/220,224

(22) Filed: Dec. 14, 2018

(51) Int. Cl. G06K 7/10; G06K 9/62; G06K 7/14

(52) U.S. Cl. CPC G06K 7/10821; G06K 7/1491; G06K 9/6212

(57) ABSTRACT

A method of reading a barcode is provided. A target containing a barcode is illuminated in a first illumination pattern by an illumination assembly. While the target is illuminated in the first illumination pattern, a first image of the target is captured and transmitted to a barcode decoder. Based on an indication of an unsuccessful attempt to decode the barcode using the first image of the target, the target is illuminated in a second illumination pattern and a second image of the target is captured, and the target is illuminated in a third illumination pattern and a third image of the target is captured. A fourth image of the target (a composite of the second and third image) is constructed using the second and third image of the target. The fourth image of the target is transmitted to the barcode decoder for decoding.

### BACKGROUND OF THE INVENTION

Reading barcodes associated with reflective surfaces (e.g., barcodes printed on glossy substrates, barcodes displayed on screens of electronic devices, barcodes covered with plastic wrap, etc.) is often difficult because reflections (e.g., from overhead lighting or other light sources) appearing on a reflective surface can obscure a barcode. This is particularly problematic in compact barcode readers, which typically include illumination LEDs positioned near the imaging optical axis to illuminate a barcode so that it can be read by the barcode reader. The light produced by these LEDs can cause specular reflections that are significantly brighter than the barcode itself, often exceeding the dynamic range of a barcode image sensor and causing local image saturation and loss of barcode elements in captured images of the barcode.

Currently, users deal with this issue by physically tilting the barcode or moving it back and forth so that LED reflections do not obscure the barcode before capturing an image of the barcode. However, this process is tiresome for users and increases the overall time needed for reading each barcode. Accordingly, there exists a need for a barcode reader that is able to read glossy barcodes more quickly, with less dependence on the distance and orientation of the barcode with respect to the barcode reader.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an exemplary block diagram schematic of a barcode reader, in accordance with an embodiment of the present invention.

FIG. 2 illustrates an exemplary configuration of a barcode reader, in accordance with an embodiment of the present invention.

FIG. 3A illustrates an image of a target barcode containing a specular reflection, in accordance with an example.

FIG. 3B illustrates a histogram of image brightness in the image of FIG. 1A, in accordance with an example.

FIG. 4A illustrates slices in the image of FIG. 1A, in accordance with an example.

FIG. 4B illustrates a waveform of the distribution of pixel values in one of the slices shown in FIG. 2A, in accordance with an example.

FIG. 5A illustrates an image of a target barcode captured when both a left-side LED and a right-side LED are illuminated, in accordance with an example.

FIG. 5B illustrates an image of a target barcode captured when only a right-side LED is illuminated, in accordance with an example.

FIG. 5C illustrates an image of a target barcode captured when only a left-side LED is illuminated, in accordance with an example.

FIG. 5D illustrates an image of a target barcode constructed from the image shown in FIG. 5B and the image shown in FIG. 5C, in accordance with an example.

FIG. 6 illustrates a flowchart representative of a method of reading a barcode, in accordance with an embodiment of the present invention.

FIG. 7 illustrates a flowchart representative of a method of constructing a new image of a target barcode from two captured images of the target barcode, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

As discussed above, reading barcodes associated with reflective surfaces (e.g., barcodes printed on glossy substrates, barcodes displayed on screens of electronic devices, barcodes covered with plastic wrap, etc.) is often difficult because reflections (e.g., glare from overhead lighting or other light sources) appearing on a reflective surface can obscure a barcode. This is particularly problematic in compact barcode readers, which typically include illumination LEDs positioned near the imaging optical axis to illuminate a barcode so that it can be read by the barcode reader. The light produced by these LEDs can cause specular reflections that are significantly brighter than the barcode itself, often exceeding the dynamic range of a barcode image sensor and causing local image saturation and loss of barcode elements in captured images of the barcode.

Currently, users deal with this issue by physically tilting the barcode or moving it back and forth so that LED reflections do not obscure the barcode before capturing an image of the barcode. However, this process is tiresome for users and increases the overall time needed for reading each barcode. Accordingly, there exists a need for a barcode reader that is able to read glossy barcodes more quickly, with less dependence on the distance and orientation of the barcode with respect to the barcode reader.

The present invention addresses this problem using an illumination assembly that includes two or more illumination sources positioned in different locations with respect to the target barcode. A first image of a barcode is captured with all of the illumination sources turned on. When a specular reflection is detected in the captured image of the barcode, or when attempts to decode the captured image of a barcode are unsuccessful during a certain amount of time (i.e., implying that there may be a specular reflection present in the captured image preventing the decoding of the barcode), some of the illumination sources are turned off, and additional images of the target barcode are captured with various combinations of the illumination sources turned on and off.

Generally speaking, because the various illumination sources are positioned in different locations with respect to the target barcode, turning one or more illumination source off will change the location of the specular reflection on the barcode. For instance, when a left-side illumination source is turned off but a right-side illumination source remains turned on, specular reflections from the right-side illumination source may appear on the right side of a captured image of the barcode. However, the left side of the captured image of the barcode may still be readable. In contrast, when a right-side illumination source is turned off but a left-side illumination source remains turned on, specular reflections from the left-side illumination source may appear on the left side of a captured image of the barcode, while the right side of the captured image of the barcode remains readable. Consequently, it is possible to use readable portions of images of the target barcode that are captured with various combinations of the illumination sources turned on and off to reconstruct a full readable image of the target barcode. The reconstructed, readable full image of the target barcode can then be sent to a barcode decoder for decoding.

In an embodiment, the present invention is a method of reading a barcode. The method comprises: illuminating, by an illumination assembly, in a first illumination pattern, a target containing a barcode; capturing, while the target is illuminated in the first illumination pattern, a first image of the target; transmitting, by a processor, to a barcode decoder, the captured first image of the target for decoding; receiving, by the processor, an indication of an unsuccessful attempt, by the barcode decoder, to decode the barcode using the first image of the target; based on the indication of the unsuccessful attempt to decode the barcode using the first image of the target: illuminating, by the illumination assembly, the target containing the barcode in a second illumination pattern; capturing, while the target is illuminated in the second illumination pattern, a second image of the target; illuminating, by the illumination assembly, the target containing the barcode in a third illumination pattern; and capturing, while the target is illuminated in the third illumination pattern, a third image of the target; constructing, by the processor, using the second image of the target and the third image of the target, a fourth image of the target, wherein the fourth image of the target is a composite image of the second image and the third image; and transmitting, by the processor, to the barcode decoder, the fourth image of the target for decoding.

In another embodiment, the present invention is a barcode reader. The barcode reader comprises: an imaging assembly configured to capture an image of a target; an illumination assembly configured to illuminate the target; a memory configured to store computer executable instructions; and at least one processor configured to interface with the imaging assembly, the illumination assembly and the memory, and configured to execute the computer executable instructions. The computer executable instructions cause the at least one processor to: cause the illumination assembly to illuminate a target containing a barcode in a first illumination pattern; cause the imaging assembly to capture, while the target is illuminated in the first illumination pattern, a first image of the target; transmit the captured first image of the target to a barcode decoder for decoding; receive an indication of an unsuccessful attempt, by the barcode decoder, to decode the barcode using the first image of the target; based on the indication of the unsuccessful attempt to decode the barcode using the first image of the target: cause the illumination assembly to illuminate the target containing the barcode in a second illumination pattern; cause the imaging assembly to capture, while the target is illuminated in the second illumination pattern, a second image of the target; cause the illumination assembly to illuminate the target containing the barcode in a third illumination pattern; and cause the imaging assembly to capture, while the target is illuminated in the third illumination pattern, a third image of the target; construct, using the second image of the target and the third image of the target, a fourth image of the target, wherein the fourth image of the target is a composite image of the second image and the third image; and transmit, to the barcode decoder, the fourth image of the target for decoding.

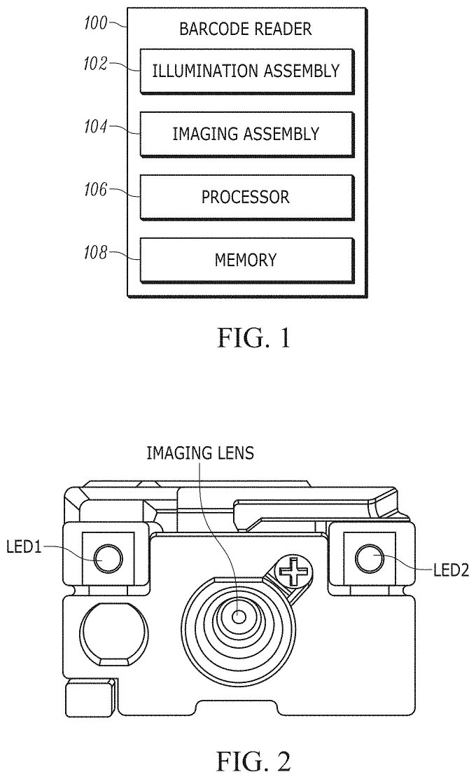

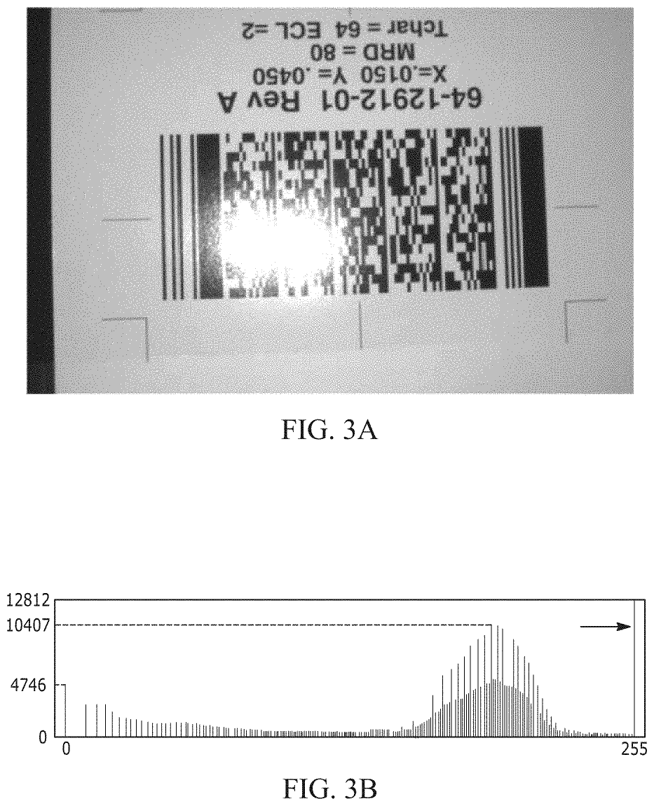

Referring now to the drawings, FIG. 1 illustrates an exemplary block diagram schematic of a barcode reader 100, in accordance with an embodiment of the present invention. As shown in FIG. 1, the barcode reader 100 may include an illumination assembly 102, an imaging assembly 104, one or more processors 106, and one or more memories 108. The illumination assembly 102 may include two or more illumination sources, which may be LEDs, positioned near the imaging optical axis to illuminate a barcode so that it can be read by the barcode reader. For instance, FIG. 2 illustrates a configuration of a barcode reader, in accordance with an embodiment of the present invention. As shown in FIG. 2, two LED illumination sources may be positioned on the left and right sides of an imaging lens of a barcode reader. The imaging assembly 104 may be a camera or other image sensor configured to capture an image of a barcode. As shown in FIG. 2, the imaging assembly 104 may include one or more lenses.

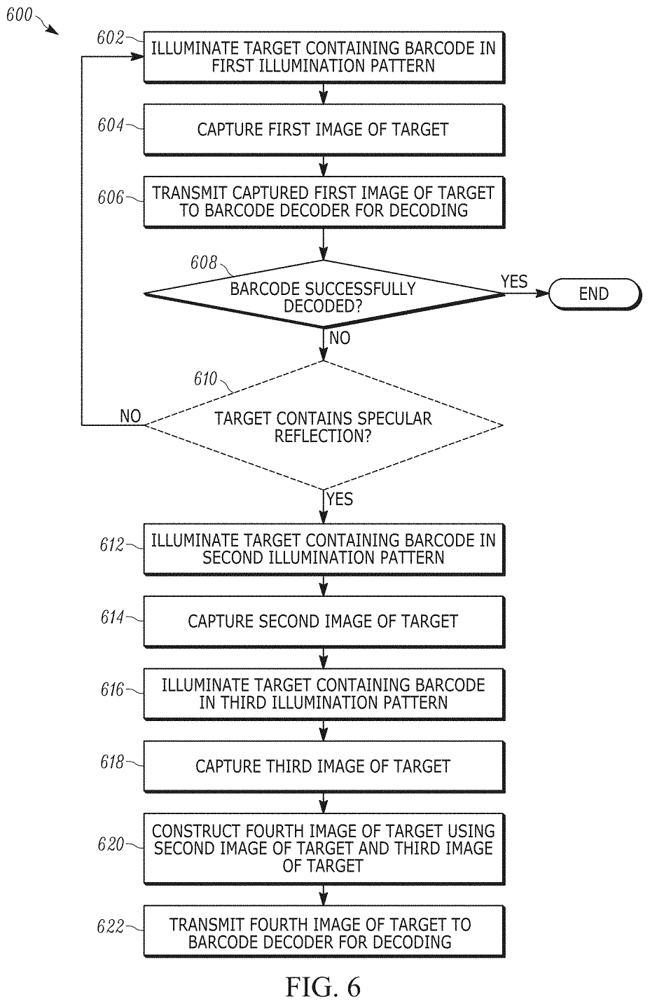

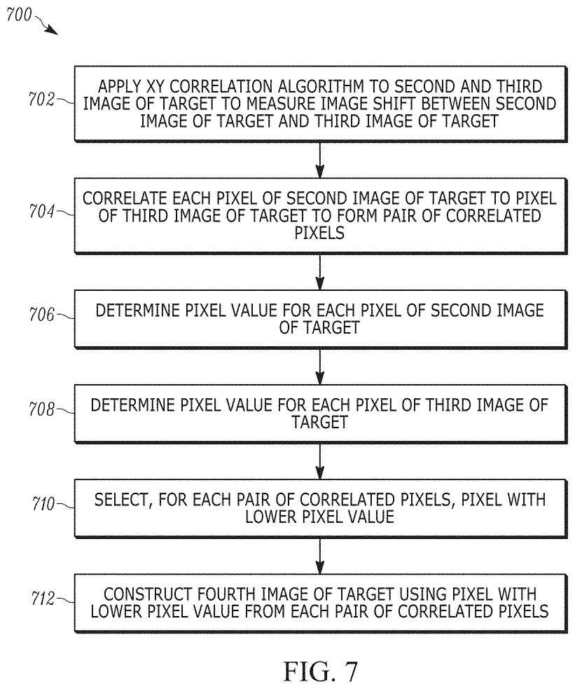

Turning back to FIG. 1, the barcode reader 100 may further include a number of various software applications (not shown) stored in the one or more memories 108. Each of the various software applications may be executed on the same processor 108 or on different processors 108, in various embodiments. Generally speaking, one or more of the applications may perform at least a portion of any of the method 600 shown in FIG. 6 and/or the method 700 shown in FIG. 7. For example, the applications may perform one or more functions related to, inter alia, illuminating barcodes in various illumination patterns, capturing images of barcodes while the barcodes are illuminating in the various illumination patterns, attempting to decode barcodes, or transmitting images of barcodes to barcode decoders for decoding, receiving indications that barcodes have not been successfully decoded, analyzing captured images of barcodes to determine that the images contain specular reflections, constructing composite images based on captured images of barcodes illuminated in various illumination patterns, e.g., by applying XY correlation algorithms to captured images to measure an image shift between the captured images, correlating the pixels of the captured images to form correlated pixel pairs, determining pixel values within each correlated pixel pair, comparing the pixel values between the correlated pixel pairs to select a lower-value pixel from each pair, constructing new images using the lower-value pixel from each correlated pixel pair, etc. In some instances, two or more of the foregoing applications may be combined as an integral application. Moreover, additional or alternative applications may be included in various embodiments.

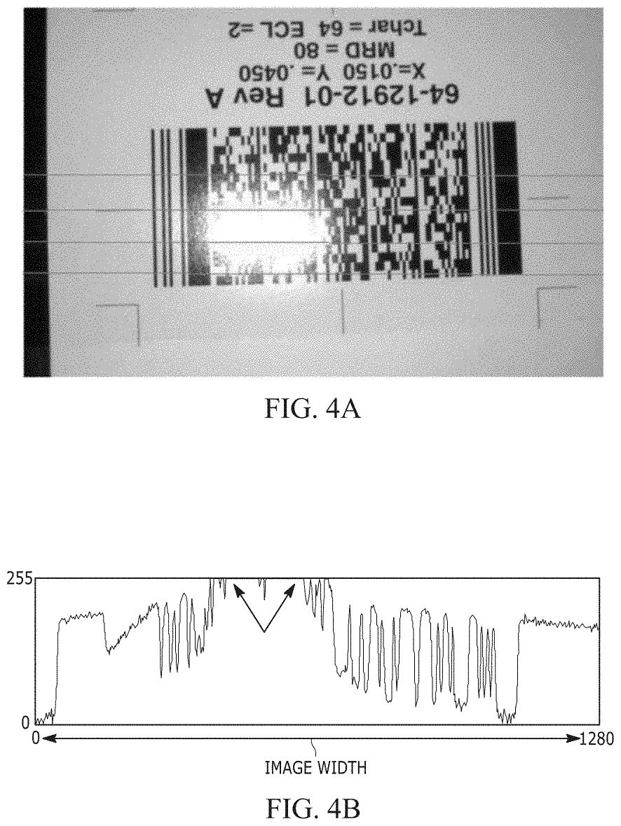

Referring now to FIG. 3A, an image of a target barcode containing a specular reflection is illustrated, in accordance with an example. There are several ways such an image may be analyzed to determine that the image contains a specular reflection.

In one example, a captured image of a target barcode may be analyzed to determine that the image contains a specular reflection by mapping the brightness of the image in a histogram, as shown in FIG. 3B. The x-axis of the histogram shown in FIG. 3B represents pixel value (with higher numbers, up to 255, representing lighter pixels and lower numbers, down to 0, representing darker pixels), while the y-axis represents number of pixels. When an image contains a specular reflection, there will be a very large number of very bright pixels due to the white “glare” of the reflection (e.g., as shown in FIG. 3A). Accordingly, when an image contains a specular reflection, the highest peak of a histogram mapping the image brightness in this way will be found at a very high pixel value, representing the large number of very bright pixels in the image. For instance, as shown in FIG. 3B, the highest peak is found at pixel value 255 (representing white pixels).

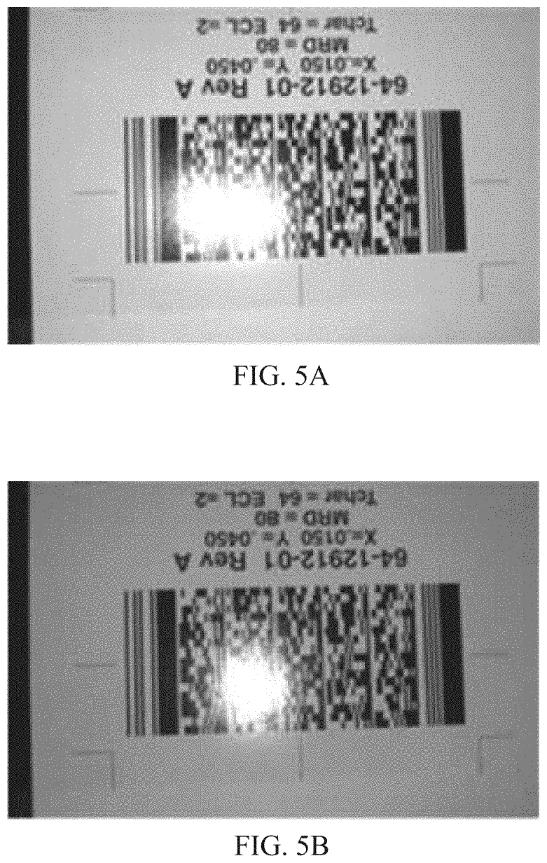

In another example, a captured image of a target barcode may be analyzed to determine that the image contains a specular reflection by analyzing “slices” of the image and generating a waveform of the distribution of pixel values in each slice. For instance, FIG. 4A illustrates locations at which four slices of the image of the target containing the specular reflection could be analyzed in this way. FIG. 4B illustrates a waveform of the distribution of pixel values in one of the slices shown in FIG. 4A. In the waveform shown in FIG. 4B, the x-axis represents the width of the image (measured in pixels), while the y-axis represents pixel value (with higher numbers, up to 255, representing lighter pixels and lower numbers, down to 0, representing darker pixels). When an image contains a specular reflection, there will be a number of very bright pixels concentrated in the part of the image where the reflection is located. Accordingly, when a slice cuts through a portion of an image containing a specular reflection, the portion of the slice containing the specular reflection will have very high pixel values. For instance, as shown in FIG. 4B, the portion of the width of the image associated with the specular reflection has pixel values at or very close to 255.

When a specular reflection is detected in the captured image of the barcode (e.g., using one of the methods described in connection with FIGS. 3A, 3B, 4A, and/or 4B), or when attempts to decode the captured image of a barcode are unsuccessful during a certain amount of time (i.e., implying that there may be a specular reflection present in the captured image preventing the decoding of the barcode), some of the illumination sources are turned off, and additional images of the target barcode are captured with various combinations of the illumination sources turned on and off.

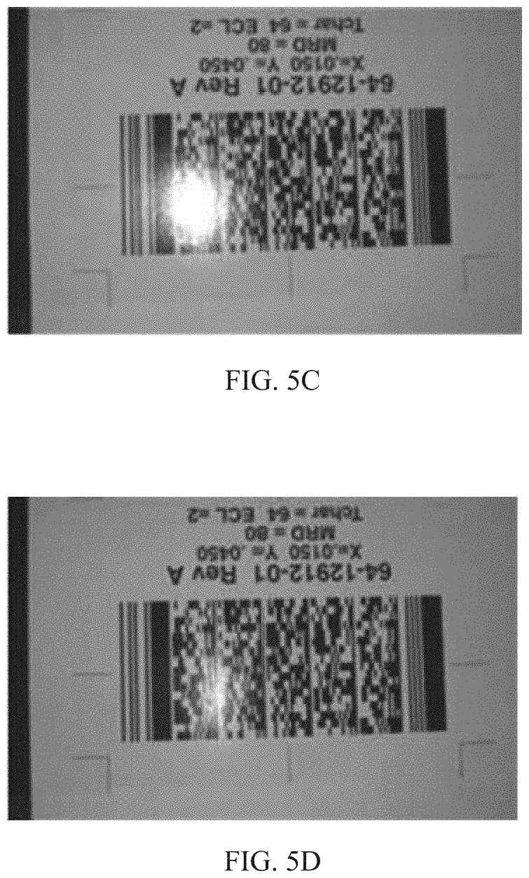

Generally speaking, because the various illumination sources are positioned in different locations with respect to the target barcode, turning one or more illumination source off will change the location of the specular reflection as it appears on the barcode. For instance, FIG. 5A illustrates an image of a target barcode captured when both a left-side LED and a right-side LED are illuminated, in accordance with an example. As shown in FIG. 5A, a large portion is unreadable when both LED illumination sources are illuminated. When the left-side illumination source is turned off but the right-side illumination source remains illuminated, e.g., as shown in FIG. 5B, specular reflections associated with the right-side illumination source appear in a first portion of a captured image of the barcode, while other portions of the captured image of the barcode may still be readable. Similarly when the right-side illumination source is turned off but a left-side illumination source remains illuminated, e.g., as shown in FIG. 5C, specular reflections from the left-side illumination source appear in a second portion of the captured image of the barcode, while other portions of the captured image of the barcode remain readable. Consequently, it is possible to use the readable portions of images of the target barcode that are captured with various combinations of the illumination sources turned on and off to reconstruct a full readable image of the target barcode. For instance, FIG. 5D illustrates an image of a target barcode constructed from the image shown in FIG. 5B and the image shown in FIG. 5C, in accordance with an example. The reconstructed, readable full image of the target barcode, e.g., as shown in FIG. 5D can then be send to a barcode decoder for decoding.

Turning now to FIG. 6, shown therein is a flowchart representative of a method 600 of reading a barcode, in accordance with an embodiment of the present invention. The method 600 can be implemented as a set of instructions stored on a computer-readable memory and executable on one or more processors.

At step 602, a target containing a barcode is illuminated in a first illumination pattern. For instance, the target containing the barcode may be illuminated by an illumination assembly that includes multiple illumination sources. The illumination sources may be LED illumination sources. The first illumination pattern may be an illumination pattern in which all of the illumination sources are illuminated.

At step 604, a first image of the target is captured while the target containing the barcode is illuminated in the first illumination pattern.

At step 606, the first image of the target is transmitted to a decoder for decoding. In some examples, the decoder may be an application stored on a memory of a barcode reader. In other examples, the decoder may be external to the barcode reader, and the first image of the target may be transmitted to the decoder via a network or other link.

At step 608, a query is made as to whether the barcode has been successfully decoded. The query may include a time threshold, e.g., has the barcode been successfully decoded one minute after it was transmitted to the decoder, has the barcode been successfully decoded 30 seconds after it was transmitted to the decoder, etc. In some instances, a response may be received indicating whether the barcode has been successfully decoded or not. If the barcode has been successfully decoded (step 608, YES), the method is complete. If the barcode has not been successfully decoded, or has not been successfully decoded during the time threshold (step 608, NO), the method proceeds to step 610. In some instances, the method skips step 610 and proceeds directly to step 612.

At step 610, the first image of the target may be optionally analyzed to determine whether the first image of the target contains a specular reflection. There are several ways in which an image of a target may be analyzed to determine whether it contains a specular reflection. For instance, a captured image of a target barcode may be analyzed to determine that the image contains a specular reflection by mapping the brightness of the image in a histogram, as shown in FIG. 3B. As another example, a captured image of a target barcode may be analyzed to determine that the image contains a specular reflection by analyzing “slices” of the image and generating a waveform of the distribution of pixel values in each slice, e.g., as shown in FIG. 4B.

Additionally or alternatively, in some embodiments, analyzing the first image of the target to determine whether the first image of the target contains a specular reflection may include analyzing pixels of the first image of the target to determine a number of pixels having a maximum pixel value and determining that the image contains a specular reflection based on the number of pixels having the maximum pixel value. In other embodiments, analyzing the first image of the target to determine whether the first image of the target contains a specular reflection may include analyzing pixels of the first image of the target to determine a frequency of pixels having a maximum pixel value and determining that the image contains a specular reflection based on the frequency of pixels having the maximum pixel value.

In still other embodiments, analyzing the first image of the target to determine whether the first image of the target contains a specular reflection may include analyzing pixels of the first image of the target to determine a number of pixels having a maximum pixel value within a certain proximity and determining that the image contains a specular reflection based on number of pixels having a maximum pixel value within a certain proximity. Moreover, in some embodiments, analyzing the first image of the target to determine whether the first image of the target contains a specular reflection may include analyzing pixels of the first image of the target to determine a number of pixels having a maximum pixel value within a portion of the first image of the target and determining that the image contains a specular reflection based on number of pixels having a maximum pixel value within the portion of the first image of the target.

If, after analysis of the first image of the target, no specular reflection is detected (step 610, NO), the method proceeds to step 602, and a fresh image of the target is captured. If, after analysis of the first image of the target, a specular reflection is detected (step 610, YES), the method proceeds to step 612.

At step 612, the target is illuminated in a second illumination pattern. The first illumination pattern may be an illumination pattern in which a certain subset of the illumination sources are illuminated while other illumination sources are turned off. For instance, if there were a left and right illumination source, the left illumination source may be illuminated while the right illumination source is turned off. At step 614, a second image of the target is captured while the target is illuminated in the second illumination pattern.

At step 616, the target is illuminated in a third illumination pattern. The first illumination pattern may be an illumination pattern in which a different subset of the illumination sources are illuminated than in step 612, while other illumination sources are turned off. For instance, at step 616, the right illumination source may be illuminated while the left illumination source is turned off. At step 618, a third image of the target is captured while the target is illuminated in the third illumination pattern.

At step 620, a fourth image of the target is constructed from the second and third image. This is discussed in greater detail with respect to FIG. 7 below. At step 622, the fourth image of the target is transmitted to a decoder for decoding. As discussed above, in some examples, the decoder may be an application stored on a memory of a barcode reader. In other examples, the decoder may be external to the barcode reader, and the first image of the target may be transmitted to the decoder via a network or other link.

Turning now to FIG. 7, shown therein is a flowchart representative of a method 700 of a method of constructing a new image of a target barcode from two captured images of the target barcode. The method 700 can be implemented as a set of instructions stored on a computer-readable memory and executable on one or more processors.

At step 702, an image registration algorithm (such as, e.g., an XY correlation algorithm) is applied to the second and third image of the target to measure an image shift between the second and third image of the target. That is, before the two images can be combined at the pixel level, they must first be registered so that the information in both images can be spatially aligned to the same pixel position in the images. This can be performed using known techniques of image registration. In general, image registration can account for many spatial transformations such as rotation, scaling, translation, and projective transformation.

In a hand-held barcode imager application, the images are typically collected at a rate of 60 frames-per-seconds (fps) resulting in a time of 16.7ms between frames. In this short amount of time, the dominant spatial transformation between the images can be represented by a simple translation in X and Y.

To determine the XY image shift between the two images, one can use the known technique of calculating the 2D normalized cross-correlation function between the images, or more efficiently between sections of the images. The location of the peak value in the 2D normalized cross-correlation function will determine the XY shift between the image.

At step 704, each pixel of the second image of the target is correlated to a pixel of the third image of the target to form a pair of correlated pixels. At step 706, a pixel value is determined for each pixel of the second image of the target. At step 708, a pixel value is determined for each pixel of the third image of the target. Generally speaking, higher pixel values correlate with lighter-colored pixels while lower pixel values correlate with darker-colored colored pixels. At step 710, the pixel with the lower pixel value from each pair of correlated pixels is selected. At step 712, a fourth image is constructed using the lower-value pixel from each pair of correlated pixels.

Because the parts of the target image obscured by specular reflections generally correspond to higher pixel values, selecting the lower-value pixel from each pair of correlated pixels allows the obscured portions of the second image of the target to be replaced with readable portions of the third image of the target in the fourth image of the target. Similarly, obscured portions of the third image of the target may be replaced with readable portions of the second image of the target in the fourth image of the target. Accordingly, the fourth image of the target may contain more readable portions than the second image of the target or the third image of the target.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of reading a barcode, comprising:
illuminating, by an illumination assembly, in a first illumination pattern, a target containing a barcode;
capturing, while the target is illuminated in the first illumination pattern, a first image of the target;
transmitting, by a processor, to a barcode decoder, the captured first image of the target for decoding;
receiving, by the processor, an indication of an unsuccessful attempt, by the barcode decoder, to decode the barcode using the first image of the target;
analyzing, by the processor, based on the indication of the unsuccessful attempt to decode the barcode using the first image of the target, the first image of the target to determine whether the image contains a specular reflection;
based on the indication of the unsuccessful attempt to decode the barcode using the first image of the target and the determination that the image contains a specular reflection:
illuminating, by the illumination assembly, the target containing the barcode in a second illumination pattern;
capturing, while the target is illuminated in the second illumination pattern, a second image of the target;
illuminating, by the illumination assembly, the target containing the barcode in a third illumination pattern; and
capturing, while the target is illuminated in the third illumination pattern, a third image of the target;
constructing, by the processor, using the second image of the target and the third image of the target, a fourth image of the target, wherein the fourth image of the target is a composite image of the second image and the third image; and
transmitting, by the processor, to the barcode decoder, the fourth image of the target for decoding,
wherein analyzing the first image of the target to determine whether the image contains a specular reflection comprises:
analyzing pixels of the first image of the target to determine a number of pixels having a maximum pixel value within a portion of the first image of the target, the portion including at least one slice of the first image of the target; and
determining that the image contains a specular reflection based on number of pixels having a maximum pixel value within the portion of the first image of the target.

2. (canceled)

3. (canceled)

4. (canceled)

5. (canceled)

6. (canceled)

7. The method of claim 1, wherein the illumination assembly includes a plurality of LEDs, and wherein, in the first illumination pattern, all of the plurality of LEDs are illuminated.

8. The method of claim 1, wherein the illumination assembly includes a plurality of LEDs and wherein, in the second illumination pattern, a first sub-section of the plurality of LEDs are illuminated, and in the third illumination pattern, a second sub-section of the plurality of LEDs are illuminated.

9. The method of claim 1, wherein constructing the fourth image of the target comprises:
applying, to the second image of the target and the third image of the target, an image registration algorithm to measure an image shift between the second image of the target and the third image of the target;
correlating, based on the measurement of the image shift, each pixel of the second image of the target with a pixel of the third image of the target to form a pair of correlated pixels;
determining a pixel value for each pixel of the second image of the target;
determining a pixel value for each pixel of the third image of the target;
selecting, for each pair of correlated pixels, the pixel with a lower pixel value; and
constructing the fourth image of the target using the pixel with the lower pixel value from each pair of correlated pixels.

10. The method of claim 9, wherein the pixel values are numerical pixel values, and wherein a lower pixel value corresponds to a darker shade and a higher pixel value corresponds to a lighter shade.

11. A barcode reader, comprising:
an imaging assembly configured to capture an image of a target;
an illumination assembly configured to illuminate the target;
a memory configured to store computer executable instructions; and
at least one processor configured to interface with the imaging assembly, the illumination assembly and the memory, and configured to execute the computer executable instructions to cause the at least one processor to:
cause the illumination assembly to illuminate a target containing a barcode in a first illumination pattern;
cause the imaging assembly to capture, while the target is illuminated in the first illumination pattern, a first image of the target;
transmit the captured first image of the target to a barcode decoder for decoding;
receive an indication of an unsuccessful attempt, by the barcode decoder, to decode the barcode using the first image of the target;
analyze, based on the indication of the unsuccessful attempt to decode the barcode using the first image of the target, the first image of the target to determine whether the image contains a specular reflection;
based on the indication of the unsuccessful attempt to decode the barcode using the first image of the target and the determination that the image contains a specular reflection:
cause the illumination assembly to illuminate the target containing the barcode in a second illumination pattern;
cause the imaging assembly to capture, while the target is illuminated in the second illumination pattern, a second image of the target;
cause the illumination assembly to illuminate the target containing the barcode in a third illumination pattern; and
cause the imaging assembly to capture, while the target is illuminated in the third illumination pattern, a third image of the target;
construct, using the second image of the target and the third image of the target, a fourth image of the target, wherein the fourth image of the target is a composite image of the second image and the third image; and
transmit, to the barcode decoder, the fourth image of the target for decoding,
wherein the computer executable instructions cause the at least one processor to analyze the first image of the target to determine whether the image contains the specular reflection by:
analyzing pixels of the first image of the target to determine a number of pixels having a maximum pixel value within a portion of the first image of the target, the portion including at least one slice of the first image of the target and
determining that the image contains a specular reflection based on number of pixels having a maximum pixel value within the portion of the first image of the target.

12. (canceled)

13. (canceled)

14. (canceled)

15. (canceled)

16. (canceled)

17. The barcode reader of claim 11, wherein the illumination assembly includes a plurality of LEDs, and wherein, in the first illumination pattern, all of the plurality of LEDs are illuminated.

18. The barcode reader of claim 11, wherein the illumination assembly includes a plurality of LEDs and wherein, in the second illumination pattern, a first sub-section of the plurality of LEDs are illuminated, and in the third illumination pattern, a second sub-section of the plurality of LEDs are illuminated.

19. The barcode reader of claim 11, wherein the computer executable instructions cause the at least one processor to construct the fourth image of the target by:
applying, to the second image of the target and the third image of the target, an image registration algorithm to measure an image shift between the second image of the target and the third image of the target;
correlating, based on the measurement of the image shift, each pixel of the second image of the target with a pixel of the third image of the target to form a pair of correlated pixels;
determining a pixel value for each pixel of the second image of the target;
determining a pixel value for each pixel of the third image of the target;
selecting, for each pair of correlated pixels, the pixel with a lower pixel value; and
constructing the fourth image of the target using the pixel with the lower pixel value from each pair of correlated pixels.

20. The method of claim 19, wherein the pixel values are numerical pixel values, and wherein a lower pixel value corresponds to a darker shade and a higher pixel value corresponds to a lighter shade.
